(19) United States
(12) Patent Application Publication
(10) Pub. No.: US 2008/0267759 A1
(43) Pub. Date: Oct. 30, 2008

(54) Order picking system

(75) Inventors: Sylvain-Paul Morency, Laval (CA); Robert Jodoin, Repentigny (CA); Marc Ducharme, Longueuil (CA); Mario Beaufort, St. Thomas De Joliette (CA)

Correspondence Address: VENABLE LLP, P.O. BOX 34385, WASHINGTON, DC, 20043-9998, US

(73) Assignee: AXIUM, INC., Montreal (CA)

(21) Appl. No.: 12/149,177

(22) Filed: Apr. 28, 2008

Related U.S. Application Data
(60) Provisional application No. 60/914,380, filed on Apr. 27, 2007.

(51) Int. Cl. B65G 57/00; B65G 60/00

(52) U.S. Cl. 414/788.8; 414/788.1; 901/31

(57) ABSTRACT

An order picking system includes a robot and pallet support shuttle which i) loads an empty pallet from an empty pallet distribution system, ii) carries the empty pallets adjacent a selected one of a plurality of SKU pallet stations including selected products; iii) charges one or a plurality of the selected products from the selected one of the SKU pallet stations on the one of the empty pallets, iv) repeats steps ii) and iii) until a mixed pallet is completed according to an order; and iv) unloads the mixed pallet onto a mixed pallet receiver to be picked up. The shuttle includes a robot and a pallet-receiving area both moving in unison on a rail. This minimizes robot traveling since the mixed pallet always travels with the robot. The order picking system is enclosed with safety fencing having limited pick and drop areas.

### CROSS-REFERENCE TO RELATED APPLICATION

This application claims the benefit of U.S. Provisional Application No. 60/914,380, filed Apr. 27, 2007, the subject content of which is incorporated herein by reference.

### BACKGROUND

Order picking, which is often called mix palletizing, is one of many palletizing methods. Order picking is used in distribution centers and warehouses for example where different product types, which may vary in dimensions and content, are manually picked and putted on a same pallet according to a customer order. The products are picked on full SKU (stock-keeping unit) pallets or from racks or shelves.

Automated or robotized mix palletizing systems and methods are known in the art. However, they involve relatively large floor space in order to allow handling of the many pallets by lift trucks, which further yield an unsecured plan.

### SUMMARY OF THE INVENTION

In accordance with a first aspect of the present invention, there is provided an order picking system comprising:

stock-keeping unit (SKU) pallet stations, each for receiving a SKU pallet including at least one layer of identical products selected from a group of products;

a mixed pallet receiver; and

a combined robot and pallet support shuttle for i) receiving an empty pallet, ii) carrying the empty pallet adjacent a selected one of the SKU pallet stations including selected products; iii) charging at least one of the selected products from the selected one of the SKU pallet stations on the empty pallet, iv) repeating steps ii) and iii) until a mixed pallet is completed according to an order; and iv) unloading the mixed pallet onto the mixed pallet receiver to be picked up.

The combined pallet support and robot shuttle comprises a robot and a pallet, both being mounted on a same shuttle for movement in unison. The robot picks the products from full SKU pallets, located along the path of the shuttle, and places the products on the mixed pallet, which is also secured to the shuttle. This minimizes robot traveling since the mixed pallet always travels with the robot.

The order picking system is enclosed with safety fencing having limited pick and drop areas.

Other objects, advantages and features of the present invention will become more apparent upon reading the following non restrictive description of illustrated embodiments thereof, given by way of example only with reference to the accompanying drawings.

### BRIEF DESCRIPTION OF THE DRAWINGS

FIG. 1 is a perspective view of an order picking system according to an illustrative embodiment of the present invention; and

FIG. 2 is a top plan view of the order picking system from FIG. 1.

### DETAILED DESCRIPTION

While the invention will be described in conjunction with illustrated embodiments, it will be understood that it is not intended to limit the scope of the invention to such embodiments.

In the following description, similar features in the drawings have been given similar reference numerals, and in order not to weigh down the figures, some elements are not referred to in some figures if they were already identified in a precedent figure.

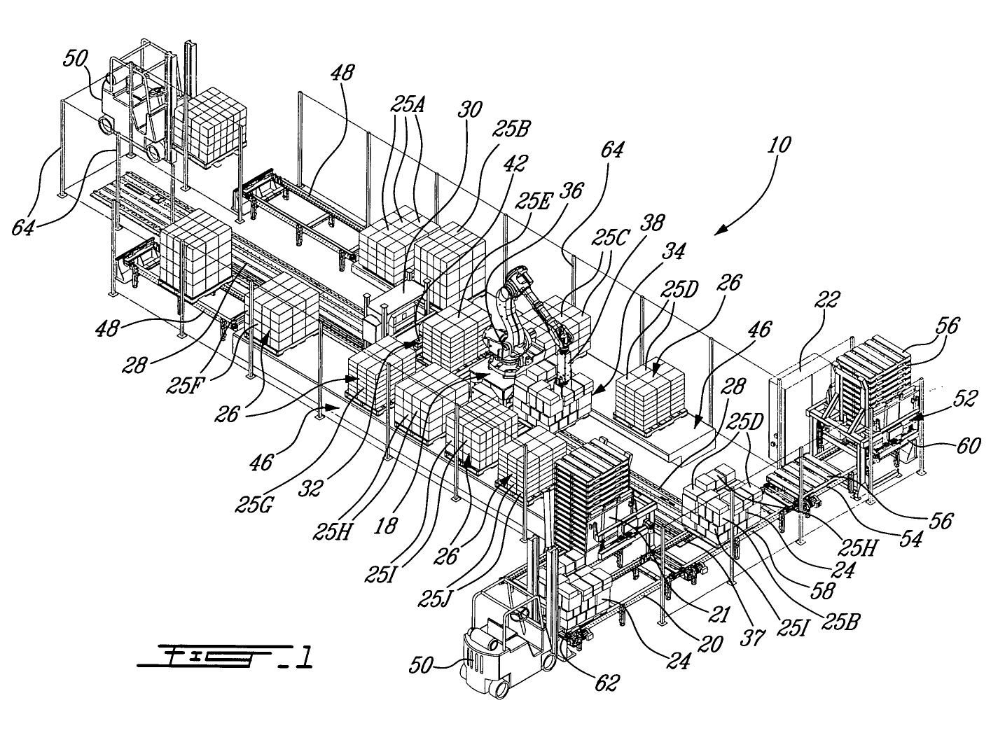

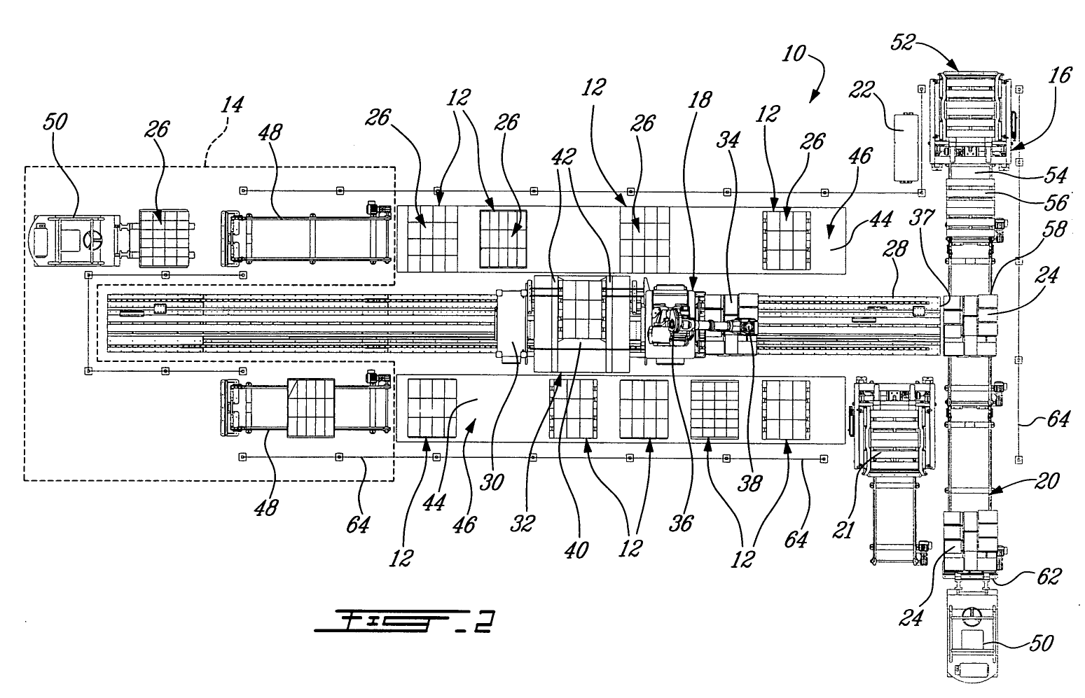

An order picking system 10 according to an illustrative embodiment of the present invention will now be described with reference to FIGS. 1 and 2. As will be described hereinbelow in more detail, the system 10 allows forming mixed pallets 24 using products 25a-25j provided on single stock-keeping unit (SKU) pallets 26.

The order picking system 10 comprises a plurality of single SKU pallet stations 12, a SKU pallet distribution system 14, an empty pallet distribution system 16, a robot and pallet support shuttle 18, a mixed pallet receiving system 20, an empty pallet receiving system in the form of an empty pallet restacker 21 and a system controller, in the form of programmable logic controller (PLC) 22. Each of the sub-systems 12-22 will now be described in more detail.

The robot and pallet support shuttle 18, which will simply be referred herein as the “shuttle” for concision purposes, includes a motorized carriage (not shown) slidably mounted on a rail 28 via for linear bearings so as to be movable along a shuttle path defined by the rail 28. The motorized carriage includes a conventional servo motor drive (not shown) to drive the shuttle 18 along the rail 28. The shuttle 18 includes a controller 30, which is coupled to and triggered by the PLC 22, to precisely control the movement and position of the motorized carriage along the rail 28 and the operations of the robot 36 with tool 38 as will be described hereinbelow in more detail.

Different controllers can alternatively be provided for each component of the shuttle 18 and/or of the system 10. Since controllers for motorized drives, robots and tools, etc. are believed to be well-known in the art of palletizing and de-palletizing, the controller 30 will not be described further herein.

The motorized carriage of the shuttle 18 supports and moves in unison a SKU pallet mover 32, a pallet-receiving area 34 and a robot 36 provided with a palletizing/depalletizing tool 38 both mounted on the carriage between the pallet mover 32 and the pallet-receiving area 34. The motorized carriage, the SKU pallet mover 32, the pallet-receiving area 34 and the robot 36 with the tool 38 together define the robot and pallet support shuttle 18.

The SKU pallet mover 32 allows positioning single SKU pallets 26 at selected pallet stations 12. For that purpose, the pallet mover 32 includes a pallet receiving table 40 and two parallel jaw members 42 mounted to the table 40 on opposite sides thereof so as to be movable towards and away each other. The two jaw members are also slidably mounted to the table 40 for reciprocal movements towards and away selected pallet stations 12. The two jaw members 42 together form a jaw which can be close on a SKU pallet for pick up.

In operation, the pallet mover 32 first opens its jaw 42. The jaw 42 then moves about the selected pallet 26. The jaw 42 then closes on the base of the selected pallet 26 and slides back on the receiving table 40. The opposite operation is performed after the shuttle 18 is positioned in front of a selected SKU pallet station 12.

The pallet mover 32 can take other form allowing to move a single SKU pallet 26 brought by the SKU pallet distribution system 14 to an empty one of the pallet stations 12. For example, according to a further illustrative embodiment of the present invention, the pallet mover includes a motorized conveyor (not show) which can selectively move pallets in either one of two opposite directions. According to this further illustrative embodiment, each of the pallet stations is in the form of a conveyor (not shown) which is selectively coupled to the pallet mover when the pallet mover is registered therewith so as to be motorized therefrom.

The pallet receiving area 34 is defined by a movable fork (not shown) mounted to the carriage. The fork allows receiving an empty pallet 56 and dropping a mixed pallet 24 formed thereon by the robot 36 at the unloading end 37 of the rail 28 to be picked up by the mixed pallet receiving system 20. It is to be noted that the fork is commanded by the PLC 22.

The robot 36 is in the form of a conventional palletizing robot such as model no. IRB 660 by ABB. Of course, other robots allowing for example movements about four (4) or six (6) axis can also be used.

The palletizing/depalletizing tool 38 is configured for mix-palletizing and more specifically for gripping products from different sizes on the pallets 26. The tool 38 includes a vacuum, side grippers, a fork tool or any combination thereof.

A tool such as the one described in US published patent application no. US-2007-0280812-A1 titled “Tool and Method for Mixed Palletizing/Depalletizing” by Axium, Inc. and which is incorporated herein by reference can for example be used.

The SKU pallet stations 12 (twelve (12) according to the illustrated embodiment) are defined by a plurality of pallet receiving areas on two elongated flat surfaces 44 parallel to the rail 28 on both sides thereof. The two elongated surfaces 44 are defined by rectangular tables 46.

According to a further illustrative embodiment (not shown), the pallet receiving areas are defined by rectangular frames having a width sufficient to receive SKU pallets 26.

The controller 30 of the shuttle 18 is so programmed that the shuttle 18 picks up SKU pallets 26 provided by the SKU pallet distribution system 14 and drops them at a selected one of the SKU pallet stations 12, which is of course empty. The two elongated surfaces 44 are so positioned relatively to the rail 28 that the pallet stations 12 are within the reach of the robots 36.

Even though the system 10 includes two elongated flat surfaces 44 parallel to the rail and positioned on opposite sides thereof, the SKU pallet stations can all be positioned on a same side of the rail. According to a further illustrative embodiment of an order picking system according to the present invention, the rail 28 defines a non linear path and the SKU pallet stations are complementary not linearly positioned.

The number, position and size of the pallet stations 12 may vary.

The SKU pallet distribution system 14 includes two full SKU pallet infeed conveyors 48, each aligned with a respective one of the two elongated flat surfaces 44. The infeed conveyors 48 receive single SKU pallets 26, each including layers of identical products 25a, 25b, 25c, 25d, 25e, 25f or 25j. Each of the pallet stations 12 may receive SKU pallets including unique products or two different pallet stations may receive identical single SKU pallets 26 depending on the application. The system 10 and more specifically the controller 22 may also be configured so as to dynamically determine the position of new single SKU pallet 26 according to the nature of the product it includes and the availability of the SKU pallet stations 12.

The single SKU pallets 26 are loaded on the feed conveyors 48 using for example a truck lift 50. Other means may also be used to load the SKU pallets onto the input conveyors 48, including without limitations further conveyors (not shown) operatively coupled to the conveyors 48. The length and configuration of the feed conveyors 48 may differ relatively to those illustrated in FIGS. 1-2.

The empty pallet distribution system 16 includes an empty pallet dispenser 52 and an empty pallet infeed conveyor 54 operatively coupled to the empty pallet dispenser 52 for receiving empty pallets 56 therefrom and for feeding the empty pallets 56 to a dual-purpose conveyor 58 which is positioned at the end 37 of the rail 28.

The empty pallet dispenser 52 allows receiving a stack of empty pallets 56 and dropping at once a single empty pallet 56 onto the empty pallet infeed conveyor 54, which extends within the frame 60 of the pallet dispenser 52 so as to be positioned under the stack of pallets 56. Since the mechanism and operation of such an empty pallet dispenser 52 is believed to be well-known in the art of palletizing, and for concision purposes, the empty pallet dispenser 52 will not be described further herein.

The mixed pallet receiving system 20 is in the form of a conveyor abutted to the dual-purpose conveyor 58. A truck-lift 50 or any other apparatus (not shown) for unloading and carrying pallets is used to unload a mixed pallet 24 from the conveyor 20. A further conveyor can alternatively be used to receive and unload mixed pallets 24 from the pallet-receiving system 20.

The empty pallet infeed conveyor 54, dual purpose conveyor 58 and mixed pallet receiving conveyor 20 are all leveled and are motorized so as to move pallets 24 and 56 in a direction from the empty pallet dispenser 52 to the unloading end 62 of the mixed pallet receiving conveyor 20.

According to a further illustrative embodiment of the present invention, a single conveyor (not shown) acts as the empty pallet conveyor 54, the dual purpose conveyor 58 and the mixed pallet receiving conveyor 20.

The empty pallet restacker 21 is positioned by the rail 28 adjacent the end 37 thereof. The empty pallet restacker 21 receives and stacks empty pallets 56 from the shuttle 18. Other means than the empty pallet restacker 21, allowing to receive an empty pallet 56 from the shuttle 18 and to dispose thereof can also be used. Such means may include, without limitations, a conveyor provided with pallet gripping means.

The controller 22 allows controlling and coordinating the operation of the components of the system 10, including the shuttle 18, the conveyors 20, 48, 54 and 58, pallet dispenser 52 and empty pallet restacker 21. Since such a controller is believed to be well-known in the palletizing and conveyor arts and for concision purposes, it will not be described further herein in more detail.

The order picking system 10 is enclosed with safety fencing 64 having only four openings, defining the following pick and drop areas: the two full SKU pallet infeed conveyors 48, the mixed pallet outfeed which is defined by the mixed pallet receiving conveyor 20, and the pallet restacker 21. It is to be noted that it is the fact that the system 10 allows for limited pick and drop areas which allows its securing with fences 64.

At the beginning of the operation of the order picking system 10, the system shuttle 18 loads each pallet station 12 with a single SKU pallet 26. More precisely, the shuttle 18 moves in front of the full SKU pallet infeed conveyors 48, the pallet mover 32 loads a single SKU pallet 26 on the shuttle 18, and unload the single SKU pallet 26 on a selected one of the empty pallet station 12. This sequence is repeated until the pallet stations 12 located along the rail 28 are loaded with a single SKU pallet 26.

A person skilled in the art would appreciate that the system 10 does not require that all pallet stations 12 be full in order to operate.

The controller 22 memorizes the type of products at each pallet station 12.

This sequence is also repeated when a single SKU pallet 26 becomes empty and has to be replaced. The empty pallet 56 is then moved by the shuttle 18 to the pallet restacker 21. Then the step of placing a new single SKU pallet 26 starts again.

Afterward, when the stations 12 includes a required single SKU pallet 26, the shuttle 18 is moved adjacent a selected pallet station 12, the robot 36 picks products on the corresponding single SKU pallet 26 using its mix-palletizing tool 38 and puts the products on the pallet receiving area 34.

The number of products simultaneously picked by the robot 36 depends on the capability of the tool 38 and/or on the customer order. Indeed, in operation, the system 10 proceeds in such a way that the shuttle 18 picks products and assembles a mixed pallet 24 according to an order inputted into the controller 22. For example, the robot 36 picks one product or a row of products or a full layer of products.

When the mixed pallet 24 is completed according to the order inputted in the controller 22, the shuttle 18 moves to the dual-purpose conveyor 58 and unloads the mixed pallet 24 thereon. The mixed pallet 24 is then moved to the unloading end 62 of the mixed pallet receiving conveyor 20 by the conveyors 58 and 20 to be picked up for example by a lift truck 50.

Finally, the shuttle 18, which is still positioned at the end 37 of the rail 28, lowers its fork towards the dual purpose conveyor 58 to load an empty pallet 56 which has been placed there by the empty pallet infeed conveyor 54 and which has been previously dropped by the pallet dispenser 52.

It is to be noted that the single SKU pallets 26 of the pallet stations 12 are handled by the shuttle 18 and not by lift trucks. This allows limiting access to the system 10 during operation thereof. The system 10 allows a single robot 36 to palletize a high number of different products in a secure environment since lift truck access is limited to four pick and drop areas: one mixed pallet exit conveyor 20, two full SKU pallet infeed conveyors 48 and the pallet dispenser 52.

Moreover, the system 10 allows minimizing the floor space.

An order picking system according to the present invention can be used in places such as distribution centers and warehouses for example.

It is to be noted that many modifications could be made to the order picking system 10 described hereinabove for example:
Even though the system 10 is illustrated in FIGS. 1 and 2 with SKU 25a-25j in the form of carton, the SKU pallets may includes any stackable products such as corrugated boxes (closed or open), plastic containers, corrugated trays, carton stacks and bags;
The conveyors 20, 48, 54, 58 can be of the belt conveyor type, roller conveyor type, etc.;
The shuttle 18 can be made movable by other means than a carriage on a rail. For example, sliding elements can be used on both the carriage and the ground. Also, an automated guided vehicle (AGV) can for example alternatively be used;
The SKU pallet mover 32 can be omitted on the shuttle 18 and other means can be provided to move the single SKU pallets 26 from the SKU pallet distribution system 14 to selected pallet stations. For example, forks or any other pallet handling means mounted on a gantry (not shown) positioned adjacent the surface 44 can alternatively be used.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. An order picking system comprising:
stock-keeping unit (SKU) pallet stations, each for receiving a SKU pallet including at least one layer of identical products selected from a group of products;
a mixed pallet receiver; and
a combined pallet support and robot shuttle for i) receiving an empty pallet, ii) carrying the empty pallet adjacent a selected one of the SKU pallet stations including selected products; iii) charging at least one of the selected products from the selected one of the SKU pallet stations on the empty pallet, iv) repeating steps ii) and iii) until a mixed pallet is completed according to an order; and iv) unloading the mixed pallet onto the mixed pallet receiver to be picked up.

2. The system as recited in claim 1, further comprising an empty pallet receiving system; the shuttle being further for taking an emptied SKU pallet on one of the SKU pallet stations and for dropping the emptied SKU pallet to the empty pallet receiving system.

3. The system as recited in claim 2, wherein the empty pallet receiving system includes an empty pallet restacker.

4. The system as recited in claim 1, further comprising an empty pallet distribution system for providing the empty pallet to the shuttle.

5. The system as recited in claim 1, wherein the shuttle is movably mounted to a rail; the SKU pallet stations are positioned adjacent the rail.

6. The system as recited in claim 5, wherein the shuttle includes a carriage mounted to the rail, a pallet receiving area on the carriage for said i) receiving the empty pallet and a robot secured to the carriage adjacent the pallet receiving area and provided with a tool for said iii) charging at least one of the selected products from the selected one of the SKU pallet stations on the empty pallet; the pallet-receiving area being movable relatively to the carriage for said iv) unloading the mixed pallet onto the mixed pallet receiver.

7. The system as recited in claim 6, further comprising an empty pallet distribution system for providing the empty pallet to the pallet-receiving area of the shuttle; the pallet-receiving area of the shuttle being further for loading the empty pallet.

8. The system as recited in claim 7, wherein the empty pallet distribution system is positioned at one end of the rail and includes an empty pallet dispenser and an empty pallet infeed conveyor operatively coupled to the empty pallet dispenser for receiving the empty pallet therefrom.

9. The system as recited in claim 6, wherein the shuttle further comprising a SKU pallet mover mounted to the carriage for receiving and moving one of the SKU pallets to or from a selected one of the SKU pallet stations.

10. The system as recited in claim 9, further comprising a SKU pallet distribution system; the SKU pallet mover being further for picking a new SKU pallet from the pallet distribution system and for unloading the new SKU pallet onto the selected one the SKU pallet stations.

11. The system as recited in claim 10, wherein the SKU pallet distribution system includes at least one SKU pallet infeed conveyor positioned adjacent the rail.

12. The system as recited in claim 9, wherein the SKU pallet mover includes a first motorized conveyor; each of the SKU pallet stations including a second conveyor for coupling to the first motorized conveyor so as to be motorized therefrom.

13. The system as recited in claim 6, wherein the pallet receiving area includes a movable fork mounted to the carriage for sequentially unloading the mixed pallet from the carriage and for loading the empty pallet thereunto.

14. The system as recited in claim 6, wherein the robot tool includes at least one of a vacuum, a gripper and a fork.

15. The system as recited in claim 6, wherein the SKU pallet stations are aligned along the rail adjacent thereto.

16. The system as recited in claim 15, wherein the SKU pallet stations form two rows, each of the two rows being positioned on a respective side of the rail.

17. The system as recited in claim 1, wherein the SKU stations and the shuttle are enclosed in fencing.

18. The system as recited in claim 1, wherein the mixed pallet receiver includes a conveyor that receives the mixed pallet from the shuttle.
